(19) United States
(12) Patent Application Publication
(10) Pub. No.: US 2018/0281291 A1
(43) Pub. Date: Oct. 4, 2018

(54) 3D OBJECT FORMING DEVICE AND 3D OBJECT FORMING METHOD

(71) Applicant: Seiko Epson Corporation, Tokyo (JP)

(72) Inventors: Masashi KUWABARA, Adachi (JP); Satoshi YAMAZAKI, Matsumoto (JP)

(21) Appl. No.: 15/913,285

(22) Filed: Mar. 6, 2018

(30) Foreign Application Priority Data
Mar. 28, 2017 (JP) 2017-062207

(51) Int. Cl. B29C 64/393; B29C 64/112; B33Y 10/00; B33Y 30/00; B33Y 50/02

(52) U.S. Cl. CPC B29C 64/393; B29C 64/112; B33Y 50/02; B33Y 30/00; B33Y 10/00

(57) ABSTRACT

When forming a 3D object by overlaying layers of an ink that solidifies to form 3D dots after being discharged, ink discharge data to discharge ink in each layer of the 3D object is produced employing formation data acquired for each layer of the 3D object. In order to produce this ink discharge data, halftone processing is performed on the formation data using a dithering method, and in the halftone processing for each of adjacent overlapping layers of the 3D object, a dither mask is applied in a different layout at equivalent positions in each layer of the 3D object formed by overlaying layers of the ink.

### BACKGROUND

### 1. Technical Field

The present invention relates to a 3D object forming device and a 3D object forming method.

### 2. Related Art

3D (three-dimensional) printers are known 3D object forming devices. 3D (three-dimensional) printers discharge ink that solidifies to form 3D dots after being discharged, and form a 3D object by overlaying layers of the discharged ink. JP-A-2015-44299 proposes a method of producing ink discharge data for each layer by performing halftone processing on formation data for an object to be formed using an error diffusion method, both within each layer and between vertically overlapping layers.

The data production method proposed in JP-A-2015-44299 is advantageous in that vertical stripes are suppressed at the surface of the 3D formed object. However, the halftone processing using the error diffusion method is performed not only within each layer, but also between vertically overlapping layers. Accordingly, complex halftone processing using the error diffusion method has to be performed plural times in order to produce the discharge data, resulting in a large calculation load. This has led to demands for a data production method capable of applying simple processing to produce ink discharge data that can suppress vertical stripes on the surface of a 3D formed object.

### SUMMARY

The invention may be implemented by the following configurations.

(1) One aspect of the invention provides a 3D object forming device. The 3D object forming device forms a 3D object by overlaying layers of an ink that solidifies to form 3D dots after being discharged. The 3D object forming device includes a nozzle, a data acquisition section, a discharge data production section, and a discharge execution section. The nozzle discharges the ink. The data acquisition section acquires formation data for the 3D object for each layer of the 3D object. The discharge data production section employs the acquired formation data to produce ink discharge data to discharge the ink in each layer of the 3D object. The discharge execution section discharges the ink from the nozzle for each layer of the 3D object. Moreover, the discharge data production section produces the ink discharge data by performing halftone processing on the formation data using a dithering method, and in the halftone processing for each of adjacent overlapping layers of the 3D object determines whether or not to form a dot of the ink by applying a dither mask in a different layout at equivalent positions in each layer of the 3D object formed by overlaying layers of the ink.

In the 3D object forming device of this aspect, the ink discharge data for each layer of the 3D object is produced by performing halftone processing using a dithering method. The halftone processing using a dithering method can be performed by simply comparing magnitudes against threshold values in a dither mask, enabling simple ink discharge data production. Moreover, in the halftone processing for each of adjacent overlapping layers of the 3D object, a dither mask is applied in a different layout at equivalent positions in each layer of the 3D object formed by overlaying layers of ink. Accordingly, ink dots are not necessarily successively formed at equivalent positions in each layer at the surface of the 3D object, thereby enabling vertical stripes to be suppressed.

(2) In the above 3D object forming device, configuration may be made wherein, in the halftone processing, the discharge data production section determines whether or not to form a dot of the ink by shifting and applying a dither mask that is the same dither mask to each of the adjacent overlapping layers of the 3D object. This eliminates the need to employ plural dither masks having different threshold values, enabling a reduction in the mask storage capacity required. Moreover, since the same dither mask is simply shifted, an increase in calculation load can be avoided or suppressed.

(3) In the above 3D object forming device, configuration may be made wherein the ink includes plural coloring inks. Accordingly, ink dots of a color included in the plural coloring inks are not necessarily successively formed at equivalent positions in layers at the surface of the 3D object, enabling vertical stripes of a single color to be suppressed.

(4) Another aspect of the invention provides a 3D object forming method. In the 3D object forming method, a 3D object is formed by overlaying layers of an ink that solidifies to form 3D dots after being discharged. The 3D object forming method includes acquiring data, producing discharge data, and executing discharge. When acquiring the data, formation data for the 3D object is acquired for each layer of the 3D object. When producing the discharge data, ink discharge data to discharge the ink in each layer of the 3D object is produced employing the acquired formation data. When executing discharge, the ink is discharged from a nozzle for each layer of the 3D object. Moreover, the ink discharge data is produced by performing halftone processing on the formation data using a dithering method, and in the halftone processing for each of adjacent overlapping layers of the 3D object, determination is made as to whether or not to form a dot of the ink by applying a dither mask in a different layout at equivalent positions in each layer of the 3D object formed by overlaying layers of the ink. This 3D object forming method is also capable of obtaining the advantageous effects discussed above.

The invention may be implemented by various configurations. For example, the invention may be implemented by a 3D object formation data production device or production method.

### BRIEF DESCRIPTION OF THE DRAWINGS

The invention will be described with reference to the accompanying drawings, wherein like numbers reference like elements.

FIG. 1 is a functional block diagram illustrating configuration of a 3D object forming system.

FIG. 2 is a perspective view schematically illustrating an internal structure of a 3D object forming device.

FIG. 3 is an explanatory diagram illustrating a recording head.

FIG. 4 is a flowchart illustrating ink discharge data generation executed by a CPU of a host computer.

FIG. 5 is an explanatory diagram illustrating a relationship between a 3D object and dots.

FIG. 6 is an explanatory diagram schematically illustrating formation data for each layer of a 3D object.

FIG. 7 is an explanatory diagram to explain a correspondence relationship between a dither mask and formation data.

FIG. 8 is an explanatory diagram schematically illustrating halftone processing employing dither masks having identical threshold value arrays for adjacent overlapping layers of a 3D object.

FIG. 9 is an explanatory diagram schematically illustrating halftone processing employing dither masks having different threshold value arrays for adjacent overlapping layers of a 3D object.

FIG. 10 is a flowchart illustrating formation processing executed by a 3D object forming device.

FIG. 11 is an explanatory diagram illustrating a 3D object formed based on ink discharge data produced using the halftone processing in FIG. 8.

FIG. 12 is an explanatory diagram illustrating a 3D object formed based on ink discharge data produced using the halftone processing in FIG. 9.

### DESCRIPTION OF EXEMPLARY EMBODIMENTS

Explanation follows regarding an embodiment of the invention, with reference to the drawings. Note that in order to facilitate understanding, the dimensions and scale of various elements in the drawings differ from reality where appropriate. The embodiment described below is a preferable specific example of the invention and includes various limitations that are desirable from a technical perspective. However, the scope of the invention is not limited to this embodiment except where specifically indicated to be essential in the following explanation.

In the present embodiment, as a 3D object forming device, explanation is given regarding an ink jet type 3D object forming device that forms an 3D object Obj by discharging a curable ink (an example of a “liquid”) such as a resin emulsion-containing resin ink or an ultraviolet-curable ink. The curable ink corresponds to ink that solidifies after discharge to form three dimensional dots.

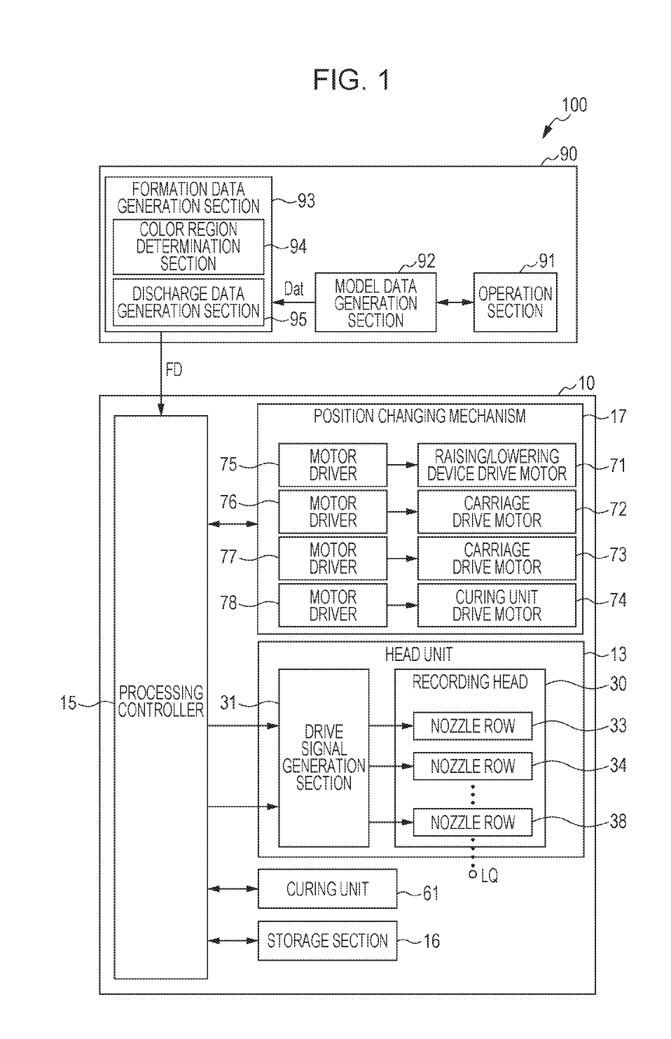

FIG. 1 is a functional block diagram illustrating a configuration of a 3D object forming system 100. As illustrated in FIG. 1, the 3D object forming system 100 includes a host computer 90 that generates data for forming a 3D object, and a 3D object forming device 10 that forms the 3D object. The 3D object forming device 10 discharges ink, and once the discharged ink has solidified, overlays with another layer of ink, thereby forming the 3D object Obj. The 3D object Obj obtained in this manner is a three-dimensionally formed object formed by building up layers of the 3D object, with each layer being formed with a predetermined thickness by dots of solidified ink. The host computer 90 executes data generation processing to generate formation data FD stipulating the shape and coloring of each of plural formation pieces configuring the 3D object Obj formed by the 3D object forming device 10.

As illustrated in FIG. 1, the host computer 90 includes a CPU (not illustrated in the drawings) that controls operation of the various sections of the host computer 90, a display section (not illustrated in the drawings) such as a display screen, an operation section 91 such as a keyboard or a mouse, a storage section (not illustrated in the drawings) stored with a control program for the host computer 90, a driver program for the 3D object forming device 10, and an application program such as computer aided design (CAD) software, a model data generation section 92 that generates model data Dat, and a formation data generation section 93 that executes data generation processing to generate the formation data FD based on the model data Dat.

The model data Dat is data expressing the shape and coloring of a model representing the 3D object Obj to be formed by the 3D object forming device 10, and is data used to designate the shape and coloring of the 3D object Obj. Note that in the following explanation, the coloring of the 3D object Obj is the manner in which plural colors are applied to color the 3D object Obj with plural colors, namely including patterns, text, and other images expressed by plural colors applied to the 3D object Obj.

The model data generation section 92 is a functional block implemented by the CPU of the host computer executing the application program stored in an information storage section. The model data generation section 92 is, for example, a CAD application, and generates the model data Dat designating the shape and coloring of the 3D object Obj based on, for example, information input through operation of the operation section 91 by a user of the 3D object forming system 100.

Note that the present embodiment envisages the model data Dat as designating the external profile and surface coloring of the 3D object Obj. In other words, assuming that the 3D object Obj is a hollow object, the model data Dat is envisaged to be data designating the shape of the hollow object, namely designating the shape of the outer profile of the 3D object Obj. For example, if the 3D object Obj is a sphere, the model data Dat expresses the shape of a spherical surface, this being the outer profile of the sphere. However, the invention is not limited thereto, and it is sufficient that the model data Dat at least includes information capable of specifying the external profile of the 3D object Obj. For example, the model data Dat may designate an internal profile of the 3D object Obj or materials of the 3D object Obj in addition to the external profile and coloring of the 3D object Obj. The model data Dat may, for example, be in a data format such as AMF (Additive Manufacturing File Format) or STL (Standard Triangulated Language).

The formation data generation section 93 is a functional block implemented by the CPU of the host computer executing the driver program for the 3D object forming device 10 stored in the information storage section. The formation data generation section 93 functions as a data acquisition section, and based on the model data Dat generated by the model data generation section 92, produces formation data FD for each layer of the 3D object so as to stipulate the shape and coloring of the formation pieces formed by the 3D object forming device 10. Moreover, the formation data generation section 93 also functions as a discharge data production section, and produces ink discharge data for each layer of the 3D object using the acquired formation data FD. In order to function as the data acquisition section and the discharge data production section, the formation data generation section 93 includes a color region determination section 94 and a discharge data generation section 95. The formation data generation section 93 executes data generation processing to produce the formation data FD stipulating the shape and coloring of the formation pieces formed by the 3D object forming device 10. In the present embodiment, the formation data generation section 93 that produces the formation data FD is provided to the host computer 90. However, the formation data generation section 93 may be provided to the 3D object forming system 100.

In the following explanation, the 3D object Obj is envisaged to be formed by layering Q stacked layers of the 3D object using the layer-shaped formation pieces (Q being a natural number satisfying Q≥2). In the following explanation, processing in which the 3D object forming device 10 forms the formation pieces is referred to as layering processing. Namely, formation processing in which the 3D object forming device 10 forms the 3D object Obj includes layering processing performed Q times.

In order to generate Q pieces of formation data FD stipulating the shape and coloring of the Q formation pieces, each having the predetermined thickness, first, the formation data generation section 93 generates cross-sectional model data having a one-to-one correspondence with the respective formation pieces by slicing a three-dimensional shape expressed by the model data Dat into sections of a predetermined thickness Lz. Note that the cross-sectional model data is data expressing the shape and coloring of a cross-sectional piece obtained by slicing the three-dimensional shape expressed by the model data Dat. Note that it is sufficient that the cross-sectional model data be data including the shape and coloring of a cross-section obtained by slicing the three-dimensional shape expressed by the model data Dat. The thickness Lz corresponds to a height direction size of a dot of ink.

Next, in order to form a formation piece corresponding to the shape and coloring expressed by the cross-sectional model data, the formation data generation section 93 determines the placement of dots to be formed by the 3D object forming device 10, and outputs the determination result as the formation data FD. Namely, the formation data FD is data designating the ink type used to form each of plural dots when the shape and coloring expressed by the cross-sectional model data are represented as a group of dots obtained by subdividing the shape and coloring expressed by the cross-sectional model data into a grid. Data expressing the dot size may also be included. Note that a dot is a three-dimensional object formed by solidifying ink corresponding to a single discharge. In the present embodiment, for simplicity, each dot is a cuboid or cube having the predetermined thickness Lz, and is a cuboid or cube having a predetermined volume. Moreover, in the present embodiment, the volume and size of each dot is determined by, for example, the pitch of the nozzles used to discharge the ink, the ink discharge interval, and the ink viscosity.

Out of the dots to be formed by the 3D object forming device 10, the color region determination section 94 determines placement regions for dots to be formed using coloring ink. The color region determination section 94 determines color regions that are to be colored by discharging coloring ink onto the surface of a group of dots of forming ink so as to suppress differences in depth in a direction normal to the surface of the 3D object Obj. For example, variation in the depth from the surface of the color regions is smoothed out.

The discharge data generation section 95 generates formation data configured by forming ink discharge data to discharge forming ink and coloring ink discharge data to discharge coloring ink.

As described above, the model data Dat according to the present embodiment designates the external profile (the shape of the outer profile) of the 3D object Obj. Accordingly, were the 3D object Obj to be formed faithfully to the shape expressed by the model data Dat, the shape of the 3D object Obj would be a hollow shape configured by only the outer profile, with no thickness. However, when forming the 3D object Obj, the shape of the inside of the 3D object Obj is preferably determined in consideration of the strength of the 3D object Obj and the like. Specifically, when forming the 3D object Obj, it is preferable that part or all of the inside of the 3D object Obj is a solid structure. Accordingly, the formation data generation section 93 according to the present exemplary embodiment generates formation data FD such that part or all of the inside of the 3D object Obj is a solid structure, regardless of whether or not the shape designated by the model data Dat is a hollow shape.

Note that depending on the shape of the 3D object Obj, sometimes no dots are present in an m^{th} layer, this being a layer on the lower side of the dots of an n^{th} layer. In such cases, it is possible that the dots might fall downward when attempting to form the dots of the n^{th} layer. Accordingly, in order to form dots at the correct dot formation positions in order to configure the formation pieces, it is necessary to provide a support portion at the lower side of the dots to support such dots. In the present embodiment, a support portion is formed by dots of an ink that solidifies similarly to the 3D object Obj. Therefore, in the present exemplary embodiment, the formation data FD includes data used to form dots that form not only the 3D object Obj, but also the support portion required in order to form the 3D object Obj. Namely, in the present exemplary embodiment, the formation pieces include both portions of the 3D object Obj to be formed on the q^{th} occasion of layering processing, and portions of the support portions to be formed on the q^{th} occasion of layering processing. In other words, the formation data FD includes both data expressing the shape and coloring of a portion of the 3D object Obj formed as the formation piece as a group of dots, and data expressing the shape of a portion of the support portion formed as the formation piece as a group of dots. The formation data generation section 93 of the present embodiment determines whether or not it is necessary to provide a support portion for dot formation based on the cross-sectional model data or the model data Dat. In cases in which the result of this determination is affirmative, the formation data generation section 93 generates formation data FD such that a support portion is provided in addition to the 3D object Obj. Note that the support portions are preferably configured from a material that can be easily removed after forming the 3D object Obj, such as a water-soluble ink. The ink used to form dots employed in the support portions is referred to as “support ink”.

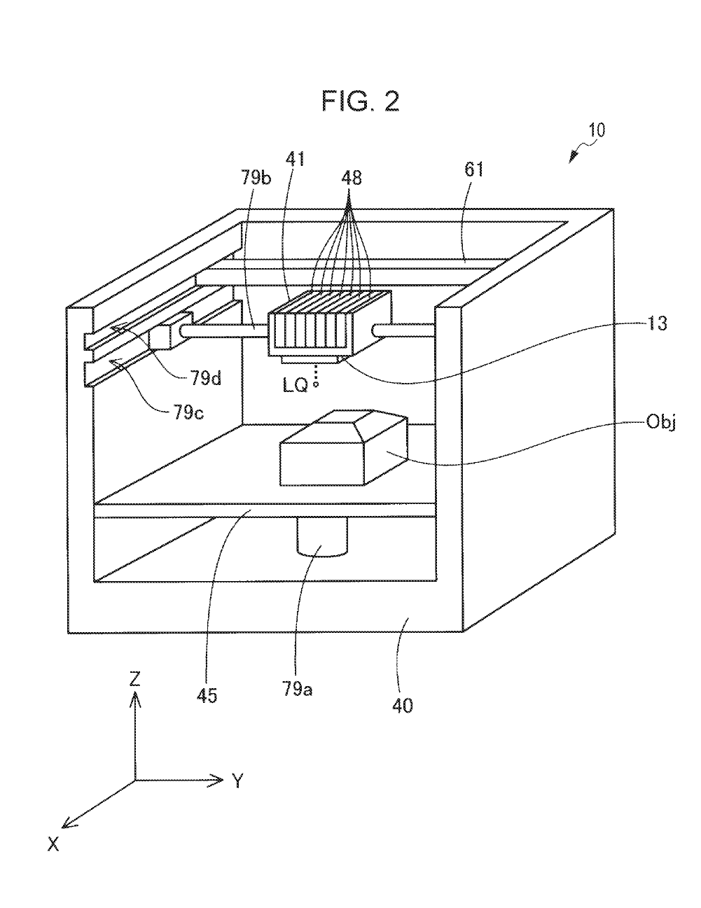

FIG. 2 is a perspective view schematically illustrating an internal structure of the 3D object forming device 10. Explanation thereof follows with reference to FIG. 1 as well as FIG. 2. As illustrated in FIG. 1 and FIG. 2, the 3D object forming device 10 includes a casing 40, a forming platform 45, a processing controller 15 that controls operation of the various sections of the 3D object forming device 10, a head unit 13, a curing unit 61, a carriage 41, a position changing mechanism 17, and a storage section 16 stored with a control program for the 3D object forming device 10 as well as various other information. The head unit 13 and six ink cartridges 48 are mounted to the carriage 41. The head unit 13 includes a recording head 30 provided with nozzle rows 33 to 38, and discharges liquid droplets LQ toward the forming platform 45 from the nozzle rows 33 to 38. The curing unit 61 cures ink that has been discharged onto the forming platform 45. The position changing mechanism 17 changes the positions of the carriage 41, the forming platform 45, and the curing unit 61 with respect to the casing 40. Note that the processing controller 15 and the formation data generation section 93 function as system controllers that control operation of the various sections of the 3D object forming system 100.

The curing unit 61 is a configuration element that cures ink that has been discharged onto the forming platform 45, and may, for example, be a light source that shines ultraviolet rays toward an ultraviolet-curable ink, or a heater that heats resin ink. In cases in which the curing unit 61 is an ultraviolet light source, the curing unit 61 is, for example, provided at an upper side (+Z direction) of the forming platform 45. In cases in which the curing unit is a heater, the curing unit 61 may, for example, be provided inside the forming platform 45, or at a lower side of the forming platform 45. The following explanation envisages a case in which the curing unit 61 is an ultraviolet light source, and envisages the curing unit 61 being positioned in the +Z direction with respect to the forming platform 45.

The six ink cartridges 48 are provided so as correspond one-to-one with a total of six types of ink, these being five colors of forming ink used to form the 3D object Obj, and the support ink used to form the support portions. Each ink cartridge 48 is filled with a type of ink corresponding to that ink cartridge 48. The five colors of forming ink used to form the 3D object Obj include chromatic color ink containing a colored colorant component (also referred to as “coloring ink”), an achromatic color ink containing an achromatic colorant component, and a clear (CL) ink with a lower colorant component content per unit weight or per unit volume than the chromatic color ink and the achromatic color ink. In the present exemplary embodiment, inks of the three colors cyan (CY), magenta (MG), and yellow (YL) are employed as the chromatic color ink. Moreover, white (WT) ink is employed as the achromatic color ink in the present embodiment. In the present embodiment, white ink refers to ink that reflects at least a predetermined proportion of light out of light shone thereon when light including wavelengths belonging to the visible range (approximately 400 nm to 700 nm) is shone onto the white ink. Note that “reflects at least a predetermined proportion of light” means the same as “absorbs or transmits less than a predetermined proportion of light”, and, for example, corresponds to cases in which the ratio of an amount of light reflected by the white ink against the amount of light shone onto the white ink is at least the predetermined proportion. In the present exemplary embodiment, the “predetermined proportion” is, for example, any proportion from 30% to 100%, and is preferably any proportion that is 50% or greater, and is more preferably any proportion that is 80% or greater. Moreover, in the present exemplary embodiment, the clear ink is ink having a lower colorant component content and having a higher transmittance than the colored ink and the achromatic color ink.

The ink cartridges 48 may be provided at another location in the 3D object forming device 10 instead of being mounted to the carriage 41.

As illustrated in FIG. 1 and FIG. 2, the position changing mechanism 17 includes a raising/lowering device drive motor 71; carriage drive motors 72, 73; a curing unit drive motor 74; and motor drivers 75 to 78. The raising/lowering device drive motor 71 drives a forming platform raising/lowering mechanism 79a on receipt of an instruction from the processing controller 15 so as to raise or lower the forming platform 45 in the +Z direction or a −Z direction (in the following explanation, the +Z direction and the −Z direction are referred to collectively as the “Z axis direction”). The carriage drive motor 72 moves the carriage 41 along a guide 79b in a +Y direction or a −Y direction (in the following explanation, the +Y direction and the −Y direction are referred to collectively as the “Y axis direction”) on receipt of an instruction from the processing controller 15. The carriage drive motor 73 moves the carriage 41 along a guide 79c in a +X direction or an −X direction (in the following explanation, the +X direction and the −X direction are referred to collectively as the “X axis direction”) on receipt of an instruction from the processing controller 15. The curing unit drive motor 74 moves the curing unit 61 along a guide 79d in the +X direction or the −X direction on receipt of an instruction from the processing controller 15. The motor driver 75 drives the raising/lowering device drive motor 71, the motor drivers 76, 77 drive the carriage drive motors 72, 73, and the motor driver 78 drives the curing unit drive motor 74.

The head unit 13 includes the recording head 30 and a drive signal generation section 31. On receipt of an instruction from the processing controller 15, the drive signal generation section 31 generates various signals, including drive waveform signals and waveform designation signals, used to drive the recording head 30, and outputs the generated signals to the recording head 30. Explanation regarding the drive signal generation section 31 and the drive waveform signals is omitted.

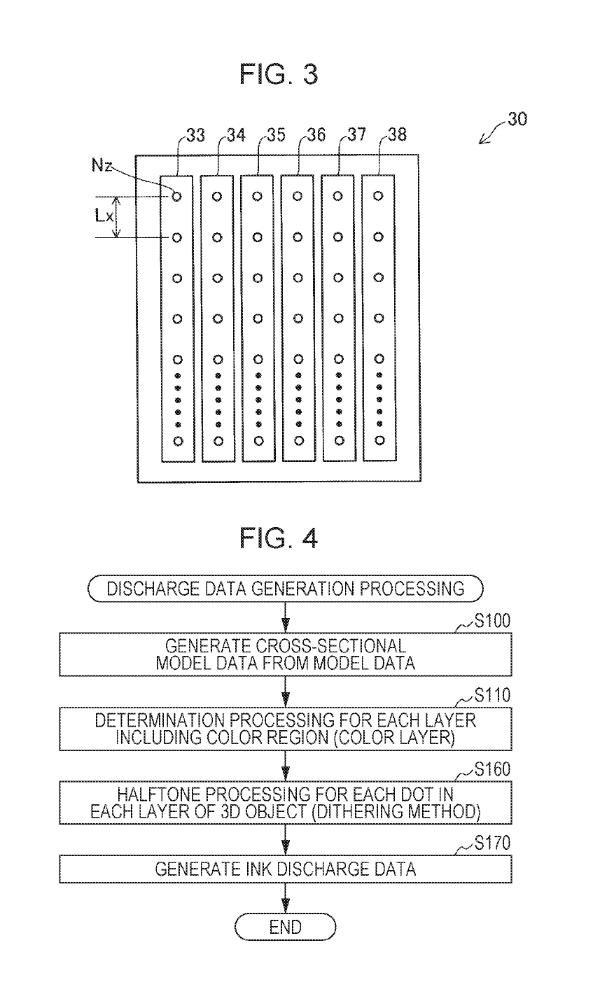

FIG. 3 is an explanatory diagram illustrating the recording head 30. The recording head 30 includes the six nozzle rows 33 to 38. Each of the nozzle rows 33 to 38 is provided with plural nozzles Nz provided spaced apart by a pitch Lx. The nozzle rows 33 to 35 includes nozzles Nz that discharge the chromatic color ink (cyan, magenta, and yellow) configuring the coloring inks. The nozzle row 36 includes nozzles Nz that discharge white ink configuring the achromatic color ink. The nozzle row 37 includes nozzles Nz that discharge the clear ink. The nozzle row 38 includes nozzles Nz that discharge the support ink. Note that with the exception of the support ink, all of the inks are employed as forming inks, and the chromatic color ink and the white ink are employed as coloring inks. Accordingly, first nozzles that discharge the forming inks include the nozzles Nz of the nozzle rows 33 to 37, and second nozzles that discharge the coloring inks include the nozzles Nz of the nozzle rows 33 to 36.

Note that in the present embodiment, as illustrated in FIG. 3, an example is given of a case in which nozzles Nz of the respective nozzle rows 33 to 38 are disposed so as to be arranged in rows in the X axis direction. However, for example, some nozzles Nz of the plural nozzles Nz configuring the nozzle rows 33 to 38 (for example even-numbered nozzles Nz) may be arrayed at different positions in the Y axis direction to the other nozzles Nz (for example odd-numbered nozzles Nz) to form what is known as a staggered pattern. Moreover, the spacing (pitch Lx) between the nozzles Nz may be set as appropriate according to the printing resolution (dpi: dots per inch) in the nozzle rows 33 to 38.

The processing controller 15 is configured including a central processing unit (CPU) and a field-programmable gate array (FPGA). The CPU and the like operate according to the control program stored in the storage section 16 so as to control operation of the various sections of the 3D object forming device 10. The storage section 16 includes electrically erasable programmable read-only memory (EEPROM), this being a type of non-volatile semiconductor memory used to store the formation data FD supplied from the host computer 90; random access memory (RAM) that temporarily retains data required in execution of the various processing, such as the formation processing to form the 3D object Obj, and in which the control program used to control the various sections of the 3D object forming device 10 is temporarily expanded in order to execute the various processing such as the formation processing; and PROM, this being a type of non-volatile semiconductor memory used to store the control program.

The processing controller 15 controls operation of the head unit 13 and the position changing mechanism 17 based on the formation data FD supplied from the host computer 90 to control execution of the formation processing to form the 3D object Obj on the forming platform 45 according to the model data Dat. Specifically, the processing controller 15 first retains the formation data FD supplied from the host computer 90 in the storage section 16. Next, the processing controller 15 controls the drive signal generation section 31 of the head unit 13 to generate various signals including drive waveform signals and waveform designation signals to drive the recording head 30 based on the various data such as the formation data FD retained in the storage section 16. The generated signals are output to the recording head 30. The processing controller 15 also generates various signals used to control operation of the motor drivers 75 to 78 based on the various data such as the formation data FD retained in the storage section 16. The generated signals are output to the motor drivers 75 to 78 to control the position of the head unit 13 relative to the forming platform 45.

In this manner, the processing controller 15 controls the position of the head unit 13 relative to the forming platform 45 by controlling the motor drivers 75 to 77, and also controls the position of the curing unit 61 relative to the forming platform 45 by controlling the motor driver 75 and the motor driver 78. The processing controller 15 also controls whether or not to discharge ink from the nozzles Nz, ink discharge amounts, ink discharge timings, and the like by controlling the head unit 13. The processing controller 15 thus controls execution of the layering processing so as to form dots on the forming platform 45 while adjusting the dot size and dot placement of the dots formed by the ink discharged onto the forming platform 45, and cure the dots formed on the forming platform 45 to form the formation pieces. Moreover, the processing controller 15 executes the layering processing repeatedly, thereby controlling execution of the formation processing to form the 3D object Obj corresponding to the model data Dat by layering new formation pieces on top of already-formed formation pieces. The processing controller 15 performing various control in this manner functions as a discharge execution section that discharges ink from the respective nozzles of the nozzle rows 33 to 38 of the head unit 13 for each layer of the 3D object.

FIG. 4 is a flowchart illustrating the generation of the ink discharge data executed by the CPU of the host computer 90. This processing is executed by the CPU corresponding to the formation data generation section 93 after the model data Dat has been produced by the model data generation section 92 of the host computer 90. When this processing is started, at step S100, the formation data generation section 93 generates the cross-sectional model data from the model data Dat. At step S110 following step S100, the color region determination section 94 determines the color regions. Specifically, the color region determination section 94 determines which of the dots DT out of the dots DT configuring each layer are to be configured by coloring ink. Note that the color region determination section 94 determines not only the color regions, but also transparent layers, masking layers, and formation layers.

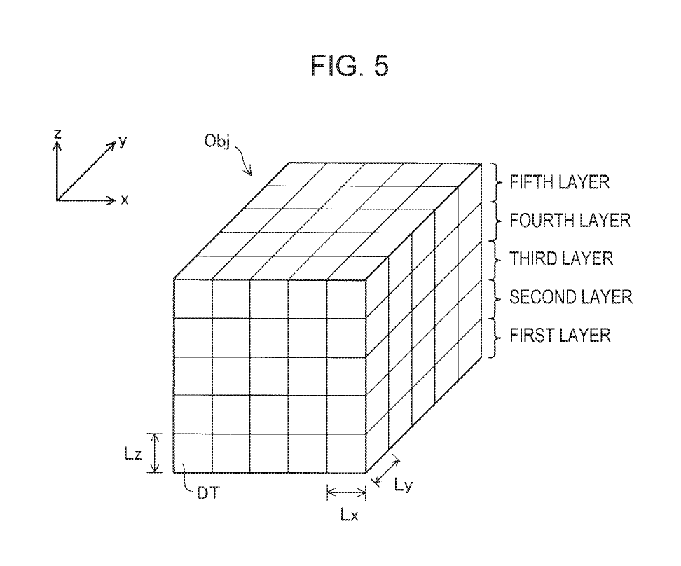

FIG. 5 is an explanatory diagram illustrating a relationship between the 3D object Obj and the dots DT. In FIG. 5, for ease of explanation, the 3D object Obj is illustrated as a cube shape formed with a first layer to an n^{th} layer (n=5). The formation data generation section 93 configures the shape of the 3D object Obj as a group of dots DT having a length, width, and height of Ly, Lx, and Lz respectively. Note that Lx is the x-direction size of the dots DT, and is equal to the pitch of the nozzles Nz. Ly is the y-direction size of the dots DT, and is the movement length of the recording head 30 according to an ink discharge interval. Lz is the z-direction size of the dots DT. Lz is determined by the viscosity and quantity of ink forming each dot. The cross-sectional model data of each layer is, for example, configured a group of the dots DT disposed two-dimensionally along the x-direction and the y-direction, and corresponds to the formation data FD for each layer of the 3D object for the respective layers in the z-direction.

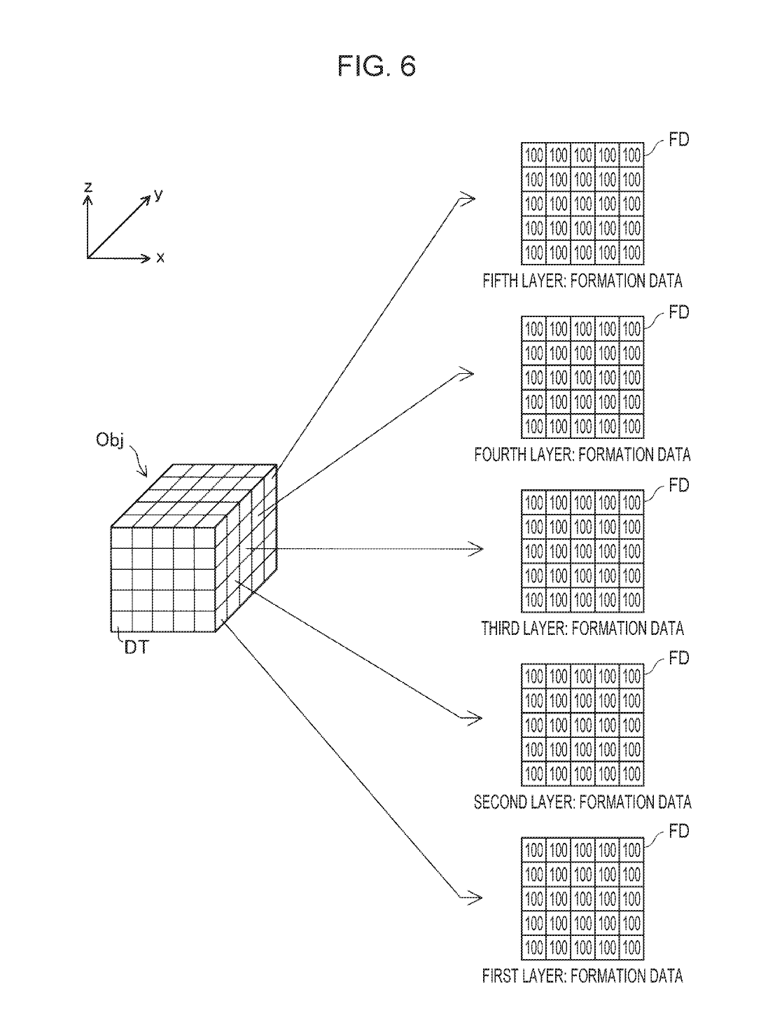

FIG. 6 is an explanatory diagram schematically illustrating the formation data FD for each layer of the 3D object Obj. The formation data FD for each layer of the 3D object, from the first layer to the fifth layer, is data configured by a 5×5 matrix, and a data value (gradation value) for each dot includes data to indicate properties of the dot, such as its color and properties, and specifically indicating properties such as whether the dot is in a color region, a transparent layer, a masking layer, or a formation layer. Note that for ease of explanation, the gradation value here is assumed to be 100 for each dot in the formation data FD for each layer. At step S110, to determine the color regions and the like, the color region determination section 94 determines not only the color regions but also transparent layers, masking layers, and formation layers based on the formation data FD. Formation layers are layers forming the main shape of the 3D object Obj. The formation layers may be formed using any ink other than the support ink. Masking layers are formed on the surface of formation layers. The masking layers are layers to mask the color of the formation layer such that the color of the formation layer is not visible, and are formed using the white ink. Color layers are formed on the surface of masking layers. Color layers correspond to color regions, and color the 3D object Obj. The color layers are formed using a coloring ink or the white ink. Note that in cases in which the gradation of the coloring ink is low, there may be regions where the coloring ink is not applied. Since the coloring ink is also a shape-configuring ink, shape defects could arise in regions not applied with the coloring ink. The white ink is used to fill such regions where the coloring ink is not applied, thereby suppressing the occurrence of shape defects. Note that the clear ink may be used for this purpose instead of the white ink. Transparent layers are layers that protect the color layers, and are formed using clear ink, this being a transparent ink. Note that the transparent layers may be omitted. A feature of the 3D object forming device 10 of the present embodiment lies in the procedure for generating the ink discharge data for the transparent layers, or for the color layers, these being the surface layers in cases in which the transparent layers are omitted. Explanation regarding the procedures used to determine the transparent layers, color layers, masking layers, and formation layers is therefore omitted.

After determining the color regions and the like as described above, following step S110 in FIG. 4, the CPU of the host computer 90 performs the processing of step S160 onward. At step S160 in FIG. 4, the discharge data generation section 95 executes halftone processing using a dithering method for all the dots in each layer, after which ink discharge data is generated (produced) at step S170. The halftone processing of step S160 is processing similar to the processing employed in a 2D printer, but differs in the following two respects. The first difference is that in a 2D printer, pixels are allocated by comparing magenta, cyan, and yellow inks, these being chromatic color ink, against dither mask threshold values. Depending on the gradation of the colored ink, sometimes dots to which no ink is allocated are present as a result of the comparison with the dither mask threshold values. In such a 2D printer, due to the presence of a medium, dots that are not allocated an ink do not create an issue. However, in the 3D object forming device 10 of the present embodiment, since the coloring inks are also used to form the dots DT configuring the shape of the 3D object Obj, defects in the 3D shape might arise due to the presence of dots DT not allocated a coloring ink. Accordingly, the discharge data generation section 95 allocates the white ink to dots DT that have not been allocated magenta, cyan, or yellow ink, these being the chromatic color ink. With the exception of this point, other processing employed in the determination of the dots of the coloring ink by comparison to dither mask threshold values is similar to that employed in a 2D printer.

The second difference is that dither masks having different threshold value arrays are employed for adjacent overlapping layers of the 3D object. Specifically, the halftone processing for the first layer of the object and the halftone processing for the second layer of the object illustrated in FIG. 6 employ dither masks having different threshold value arrays. Similar also applies to the second layer and the third layer, the third layer and the fourth layer, and the fourth layer and the fifth layer. Detailed explanation follows regarding this point.

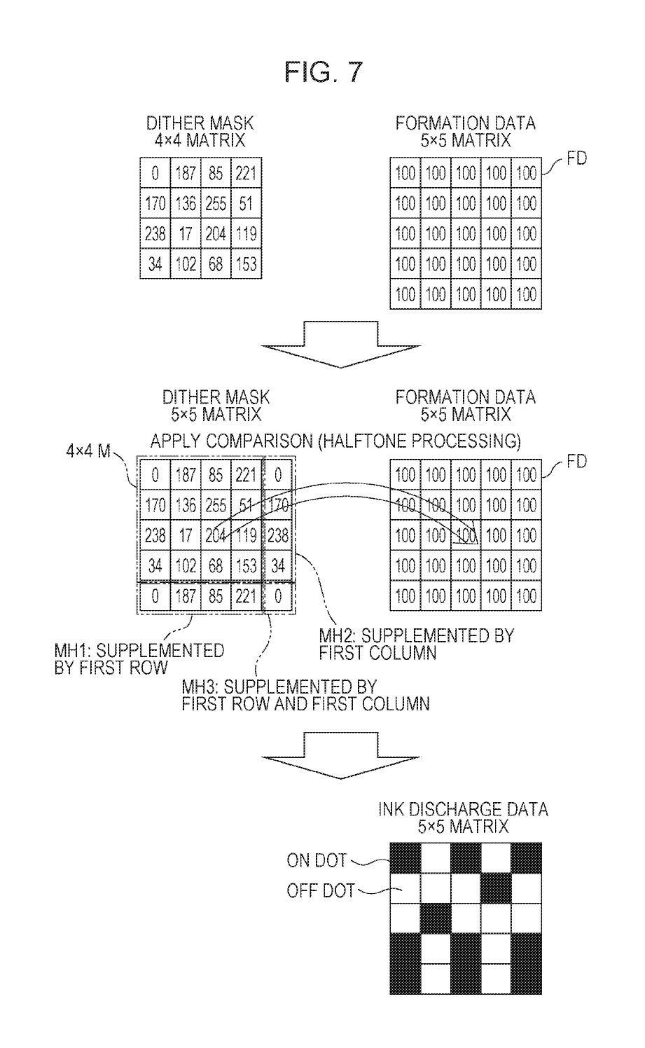

FIG. 7 is an explanatory diagram to explain a correspondence relationship between dither masks and the formation data FD. As illustrated in FIG. 7, the dither mask has a 4×4 matrix structure, whereas the formation data FD has a 5×5 matrix structure, this being larger than that of the dither mask. Note that the above matrix structures are used to simplify explanation regarding the halftone processing. In reality, the 3D object forming device 10 employs dither masks with matrix structures having multiple rows and columns, for example 64×64, 512×512, or 1024×1024, while the formation data FD for the respective layers of the 3D object corresponding to the actual 3D object Obj has an even larger matrix structure.

Since the dither mask has a smaller matrix structure than the formation data FD, a 5×5 dither mask is generated using a dither mask with a 4×4 matrix structure. Namely, as illustrated in FIG. 7, a first supplementary region MH1, a second supplementary region MH2, and a third supplementary region MH3, these being regions for which a 4×4 matrix structure would be insufficient, are produced using a dither mask with a 4×4 matrix structure. The threshold values in the first row of the 4×4 matrix-structured dither mask are employed in the first supplementary region MH1. The threshold values in the first column of the 4×4 matrix-structured dither mask are employed in the second supplementary region MH2. The threshold value in the first row and first column of the 4×4 matrix-structured dither mask is employed in the third supplementary region MH3. The 5×5 dither mask is generated in this manner, and this 5×5 dither mask is employed in binarization in the halftone processing in which the 5×5 dither mask is compared against the 5×5 formation data FD. As illustrated in the lower part of FIG. 7, in this halftone processing, dots having a gradation value exceeding the respective threshold value in the 5×5 dither mask configure ON dots, blacked-out in FIG. 7. Dots having a gradation value of the threshold value or lower configure OFF dots, illustrated in white in FIG. 7. Note that OFF dots do not mean that ink is not discharged in that dot, but that as described above, white ink is discharged instead of the magenta, cyan, or yellow ink, these being the chromatic color ink, such that defects in the 3D shape do not arise.

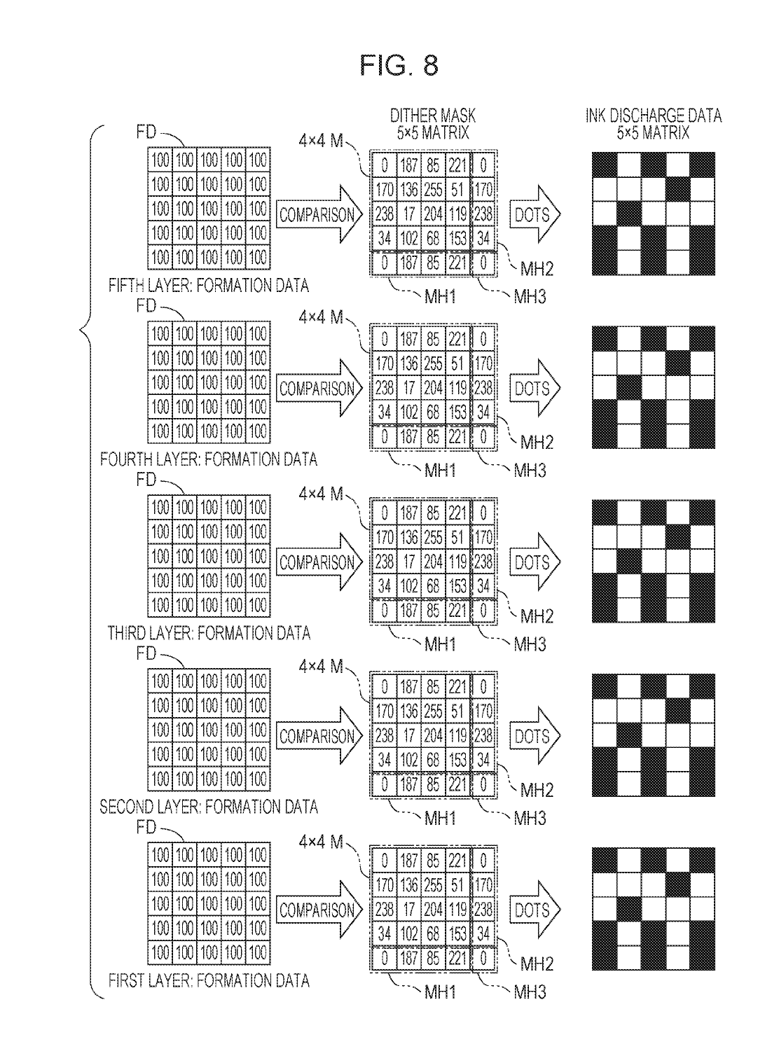

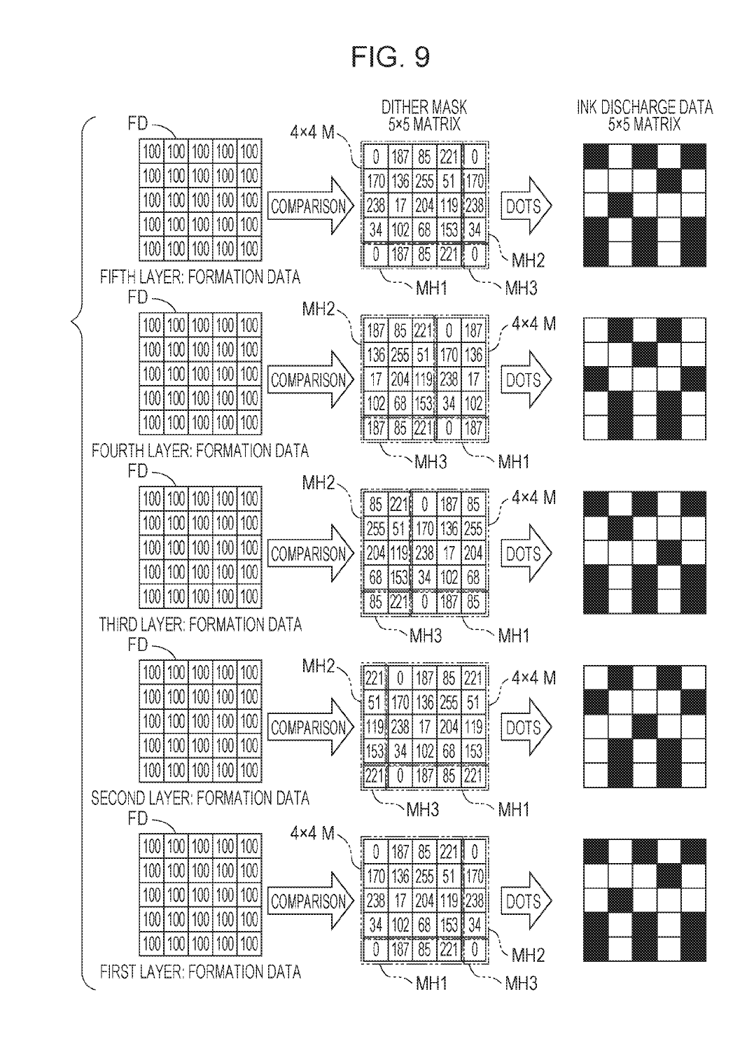

Next, explanation follows regarding halftone processing employing the 5×5 dither mask generated as described above. FIG. 8 is an explanatory diagram schematically illustrating halftone processing employing a dither mask that uses the same threshold value array for adjacent overlapping layers of the 3D object. FIG. 9 is an explanatory diagram schematically illustrating halftone processing employing a dither mask that uses different threshold value arrays for adjacent overlapping layers of the 3D object. The halftone processing illustrated in FIG. 8 is illustrated by way of contrast to the characteristic halftone processing employed in the 3D object forming device 10 of the present embodiment.

In the halftone processing illustrated in FIG. 8, the dither mask employed uses the same threshold value array for the formation data FD of each layer of the 3D object, from the first layer to the fifth layer. Therefore, the arrangement of the blacked-out ON dots and the white OFF dots is the same in each layer of the object. Ink discharge data in which the arrangement of the ON dots and the OFF dots is the same in each layer of the object is then produced at step S170. However, in the halftone processing illustrated in FIG. 9 employed by the 3D object forming device 10 of the present embodiment, the 5×5 dither mask employed for the formation data FD in the first layer illustrated in the bottom row of FIG. 9 is employed for the second layer shifted toward the right of the drawing by one dot column. Namely, the 4×4 dither mask used to configure the 5×5 dither mask employed for the formation data FD of the first layer is shifted by one dot column toward the right, and the first supplementary region MH1 to the third supplementary region MH3 are produced using this 4×4 matrix structure dither mask for the insufficient regions resulting from shifting the 4×4 matrix structure. In such cases, 5×5 dither masks shifted with respect to a virtual dither mask configured in advance by arranging 4×4 dither masks around the periphery of an identical 4×4 dither mask may be employed. In this manner, the adjacent first and second layers of the object are subject to halftone processing using a dithering method employing dither masks with different threshold value arrays. Similar applies for the second layer and the third layer, the third layer and the fourth layer, and the fourth layer and the fifth layer. Accordingly, in the halftone processing for the adjacent overlapping layers of the 3D object, different threshold values are applied at equivalent positions in the dither masks in the respective layers of the 3D object formed by overlaying layers of ink. Accordingly, in the halftone processing in FIG. 9, the arrangement of the blacked-out ON dots and the white OFF dots varies between adjacent overlapping layers of the 3D object. Ink discharge data in which the arrangement of the OFF dots and the ON dots varies between each layer is then produced at step S170. The ink discharge data produced in this manner includes ink discharge data used to discharge the various inks, and includes forming ink discharge data used to discharge the forming ink (inks excluding the support ink), and coloring ink discharge data used to discharge the coloring inks (the chromatic color ink and the white ink).

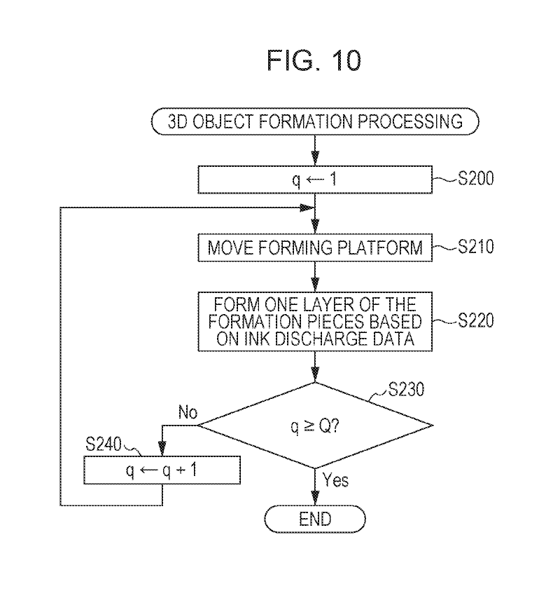

FIG. 10 is a flowchart illustrating formation processing executed by the processing controller 15 of the 3D object forming device 10. This processing is started following the production of the ink discharge data described above. When the processing of FIG. 10 is started, the processing controller 15 assigns a variable q a value of 1 (step S200). q is a variable indicating the layer number, and when q is 1, this means the first layer of the object from the lower side in the z-direction is to be formed. At the following step S210, the processing controller 15 controls the position changing mechanism 17 to move the forming platform 45 to an appropriate height for forming the formation piece of the first layer. At step S220, the formation piece of the first layer is formed based on the ink discharge data. Specifically, the processing controller discharges various inks onto the forming platform 45 through the nozzles Nz of the nozzle rows 33 to 38, and then solidifies the inks using the curing unit 61 to form the dots DT. At step S230, the processing controller 15 determines whether or not q≥Q. Q is the number of formation piece layers configuring the 3D object Obj. When q≥Q, generation of all of the formation pieces from the 1^{st} layer to the Q^{th} layer has been finished and generation of the 3D object Obj is complete, and the processing controller 15 therefore ends the processing. On the other hand, when q<Q, processing transitions to step S240, and the variable q is incremented by 1. Processing then transitions to step S210. On the second occasion onward, in the processing at step S210, the position changing mechanism 17 lowers the forming platform 45 by the height Lz of the dots DT. Processing then transitions to step S220, and similar processing is repeated until q≥Q at step S230.

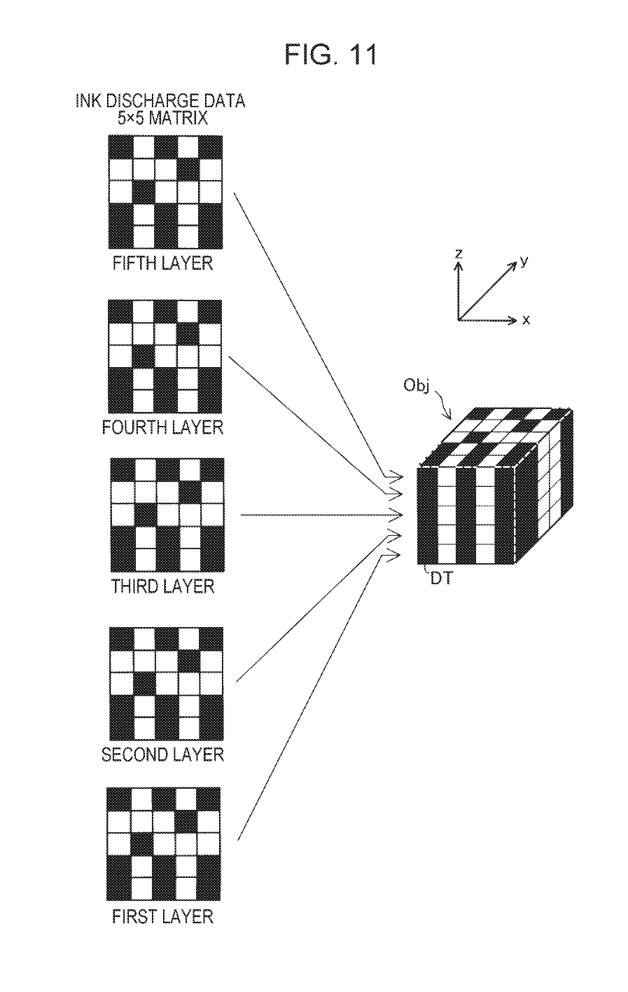

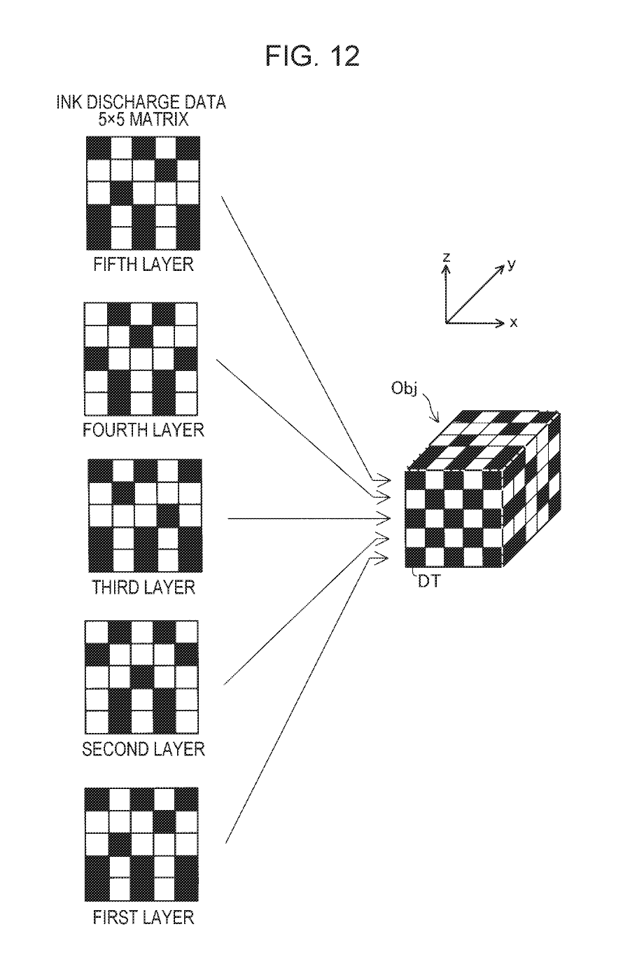

FIG. 11 is an explanatory diagram illustrating a 3D object Obj formed based on the ink discharge data produced by the halftone processing in FIG. 8. FIG. 12 is an explanatory diagram illustrating a 3D object Obj formed based on the ink discharge data produced by the halftone processing in FIG. 9. As illustrated in FIG. 11, in the 3D object Obj formed based on the ink discharge data corresponding to FIG. 8, the arrangement of the ON dots and the OFF dots is the same in adjacent overlapping layers of the object, as described above. This results in vertical stripes in the XZ plane and the YZ plane along the direction of overlap of the layers of the object. However, in the 3D object Obj formed based on the ink discharge data corresponding to FIG. 9, the arrangement of the ON dots and the OFF dots varies in adjacent overlapping layers of the object, as described above, thereby suppressing the occurrence of vertical stripes in the XZ plane and the YZ plane along the direction of overlap of the layers of the object.

As described above, when the 3D object forming device 10 of the present embodiment produces the ink discharge data for each layer of the 3D object in order to configure the 3D object Obj, the halftone processing that uses a dithering method can be performed by simply comparing magnitudes against the threshold values in the dither mask. Moreover, in the halftone processing for adjacent overlapping layers of the 3D object, dither masks having different threshold value arrays are employed such that different threshold values are applied at equivalent positions in the respective layers of the 3D object formed by overlaying layers of ink. As a result, in the 3D object forming device 10 of the present embodiment, vertical stripes can be easily suppressed by not successively forming ink dots at equivalent positions in respective layers at the surface of the 3D object Obj.

The 3D object forming device 10 of the present embodiment employs the same dither mask in the halftone processing of adjacent overlapping layers of the 3D object by shifting the dither mask for each layer such that different threshold values are applied at equivalent positions in each layer of the 3D object formed by overlaying layers of ink. Accordingly, in the 3D object forming device 10 of the present embodiment, there is no need to employ plural dither masks having different threshold values, thereby enabling a reduction in the mask storage capacity required. Moreover, due to simply shifting the same dither mask, an increase in the calculation load on the processing controller 15 can be avoided or suppressed.

The invention is not limited to the embodiments, examples, and modified examples described above, and may be implemented by various configurations within a range not departing from the spirit of the invention. For example, the technical features contained in the embodiments, examples, and modified examples that correspond to the technical features of the various configurations described in the “Summary” section may be swapped or combined as appropriate in order to address some or all of the issues mentioned, or in order to achieve some or all of the advantageous effects mentioned. Moreover, any technical feature that is not explicitly described as being essential in the present specification may be omitted as appropriate.

The embodiment described above employs the same dither mask that is shifted by one dot column at a time along the column direction. However, the dither mask may be shifted by different numbers of columns between adjacent overlapping layers of the object. For example, the dither mask may be shifted by one dot column between the first layer and the second layer, and be shifted by two dot columns between the second layer and the third layer. Moreover, the dither mask may be shifted by irregular numbers of columns. Alternatively, the same dither mask may be shifted by one dot row, or by different numbers of rows, in the row direction. The same dither mask may be rotated by a specific angle of, for example, 90°, or may be inverted along the column direction or the row direction.

In the embodiment described above, the same dither mask is shifted such that different threshold values in the dither mask are applied at equivalent positions in each layer of the 3D object formed by overlaying layers of ink. However, different dither masks having different threshold value arrays may be employed for each layer. This is another way of applying a dither mask having a different layout at equivalent positions in the respective layers of the 3D object formed by overlaying layers of ink.

The ink discharged from the head unit may be a thermoplastic liquid such as a thermoplastic resin. In such cases, the head unit may heat the liquid and discharge the liquid in a molten state. Moreover, the curing unit may be a location in the 3D object forming device where liquid dots from the head unit are cooled and solidified. This technology encompasses both “curing” and “solidification”. Moreover, liquids that undergo different curing or solidification processes may be employed as the forming inks and the support ink. For example, an ultraviolet-cured resin may be employed for the forming inks, while employing a thermoplastic resin for the support ink.

The curing unit 61 may be mounted to a carriage.

Configurations obtained by substituting or modifying combinations of the respective configurations disclosed in the above examples with each other, and configurations obtained by substituting or modifying combinations of known technology and/or the respective configurations disclosed in the above examples, and the like, may also be implemented. Such configurations are encompassed by the invention.

The entire disclosure of Japanese Patent Application No. 2017-062207, filed Mar. 28, 2017 is expressly incorporated by reference herein.

What is claimed is:

1. A 3D object forming device that forms a 3D object by overlaying layers of an ink that solidifies to form 3D dots after being discharged, the 3D object forming device comprising:
a nozzle that discharges the ink;
a data acquisition section that acquires formation data for the 3D object for each layer of the 3D object;
a discharge data production section that employs the acquired formation data to produce ink discharge data to discharge the ink in each layer of the 3D object;
a discharge execution section that discharges the ink from the nozzle for each layer of the 3D object; and
the discharge data production section producing the ink discharge data by performing halftone processing on the formation data using a dithering method, and in the halftone processing for each of adjacent overlapping layers of the 3D object determining whether or not to form a dot of the ink by applying a dither mask in a different layout at equivalent positions in each layer of the 3D object formed by overlaying layers of the ink.

2. The 3D object forming device of claim 1, wherein in the halftone processing the discharge data production section determines whether or not to form a dot of the ink by shifting and applying a dither mask that is the same dither mask to each of the adjacent overlapping layers of the 3D object.

3. The 3D object forming device of claim 1, wherein the ink includes a plurality of coloring inks.

4. A 3D object forming method for forming a 3D object by overlaying layers of an ink that solidifies to form 3D dots after being discharged, the 3D object forming method comprising:
acquiring formation data for the 3D object for each layer of the 3D object;
producing ink discharge data to discharge the ink in each layer of the 3D object by employing the acquired formation data;
executing to discharge the ink from a nozzle for each layer of the 3D object; and
when producing the discharge data, producing the ink discharge data by performing halftone processing on the formation data using a dithering method, and in the halftone processing for each of adjacent overlapping layers of the 3D object determining whether or not to form a dot of the ink by applying a dither mask in a different layout at equivalent positions in each layer of the 3D object formed by overlaying layers of the ink.
